(19) United States
(12) Patent Application Publication
(10) Pub. No.: US 2002/0026332 A1
(43) Pub. Date: Feb. 28, 2002

(54) System and method for automated creation of patient controlled records

(76) Inventors: Guy B. Snowden, Vero Beach, FL (US); Paul R. Averill, Coral Springs, FL (US); Lynn D. Smith, Dana Point, CA (US)

Correspondence Address: Akerman, Senterfitt & Eidson, P.A., Post Office Box 3188, West Palm Beach, FL, 33402-3188, US

(21) Appl. No.: 09/908,524

(22) Filed: Jul. 18, 2001

Related U.S. Application Data
(63) Continuation of application No. 09/729,376, filed on Dec. 4, 2000.
(60) Provisional application No. 60/169,065, filed on Dec. 6, 1999.

(51) Int. Cl. G06F 17/60

(52) U.S. Cl. 705/3

(57) ABSTRACT

A secure repository is provided for personal medical records of individuals and families. These electronic records, owned and controlled by the individual, may then be made accessible in selected parts over secured lines, to appropriate care providers, insurers and suppliers. The individual can direct that his or her entire file be transmitted to a doctor or to a hospital emergency room through the use of a coded card or they can direct that their medical information can only be supplied in anonymous, summary form along with data of other insured's to employers/health plan sponsors.

### CROSS REFERENCE TO RELATED APPLICATIONS

This application is a continuation of U.S. application Ser. No 09/729,376 entitled “System and Method for Automated Create of Patient Controlled Records,” filed on Dec. 4, 2000, and claims the benefit of U.S. Provisional Application No. 60/169,065 filed Dec. 6, 1999.

### FIELD OF THE INVENTION

The present invention relates to a system and method for creating, maintaining and automatically updating a consumer-owned and controlled personal electronic health record. The invention allows consumers to decide how, when and where their medical information is to be accessed and used, resulting in data security becoming an integral part of the process.

Definitions*

Algorithm

A mathematical rule or procedure to solve a problem.

Batch Processing

Transaction processing in which data is gathered and stored for later execution.

Block Diagrams

Diagrams using standardized symbols to represent flows of data between processes and sub-processes.

Computer Program

Set of instructions in a programming language that describes data processing to be performed by a computer/computer system.

Computer System

A system of computers or computer-controlled devices that execute programs to process data.

Computer Transaction

Event that generates or modifies data stored in a computer information system.

Encryption

Process of coding data to make it meaningless to someone who steals or attempts to misuse it.

Data

Facts, images, or sounds that generally are pertinent or useful for a particular task.

Database

Collection of information stored in a particular format that is typically arranged for ease and speed of retrieval from a computer.

Database Management System

Integrated set of programs used to define, update and control information.

Database Security

Procedures, policies and devices for the protection of data from accidental or intentional, but unauthorized, modification, destruction, or disclosure.

Fully Insured Health Plan

A financial arrangement between an insurance company or health maintenance/managed care organization which is at financial risk for health care services provided.

Healthcare Administrators

Administrators of health plans (including workers' compensation) which include Third Party Administrators (TPAs), insurance companies, Health Maintenance Organizations (HMOs), Managed Care Organizations (MCOs) such as Preferred Provider Organizations/Point of Service (PPOs.POSs), and Pharmacy Benefit Managers (PBMs), etc.

Healthcare Consumer

Someone who uses and/or purchases health related services or products, including a person who purchases health coverage through an insurance company, or Health Maintenance/Managed Care Organization, etc.

Healthcare Providers

Licensed providers of care related to medical, prescription, dental and vision, such as doctors, pharmacists, hospitals, disease management organizations, clinics, laboratories, etc.

HealthRésumé™

Trademark name for one of the products and services of MedeWorks, Inc. Through HealthResume™, personal healthcare information is collected from existing records, updated automatically and securely stored.

Health Plan

A program or an arrangement whereby care is provided for medical, prescription, dental, and/or vision, including reimbursement of covered expenses.

Health Plan Sponsor

An organization such as an employer, labor union, association, consolidated business entity, etc. responsible for maintaining various health related plans such as medical, prescription, dental and/or vision.

Integrated Software and Systems

Computer software and systems whose internal operations are closely linked.

Internet

System of worldwide linked computers and computer systems open for commercial use through various technologies and services, which convey information.

Managed Care

Proactively managing medical occurrences to help ensure that the most effective patient care is delivered, enhancing wellness and reducing claim expense.

Medical Records

Confidential personal bodies of information, either in paper or electronic form, resulting from occurrences of medical care rendered, including personal and family medical history, clinical summaries, hospitalizations, laboratory and imaging test results, prescribed and over-the-counter medications, outpatient treatment, and therapy services, etc. The sources of information contained in medical records generally result from: licensed care providers such as a doctor, hospital, or pharmacy; administrators of health plans such as a third party administrator or an insurance company; as well as from the patient, etc.

Networked Computers/Technoloqy

Set of devices linked to transmit data electronically between different locations.

Portable/Portability

Characteristic of software and information, which can be used in different places and with different modes of computers.

Processing

Identifying and naming data, subdividing it into basic elements, and defining internal links so it can be used and studied.

Real Time Processing

Transaction processing which occurs as soon as complete data becomes available.

RiskProfiler™

Trademark name for one of the products and services of MedeWorks, Inc. Through RiskProfiler™, individuals are profiled and identified as being of high risk in the future to develop health problems. Identification is through risk factors such as current health and wellness life style, family medical history, non-compliance with physician directives, etc.

Secure Computer Links

Process to ensure that transmitted and stored data is not vulnerable to unauthorized uses, sabotage, or criminal activity.

Self-insured Health Plan

A financial arrangement typically between a health plan sponsor, such as an employer, which has financial risk and a third party administrator or health insurance company to process health claims.

Software

Programs that control the processing performed by a computer system.

Third Party Administrators/Payors

Refers to organizations that reviews claims and makes payments in accordance with the terms of a health plan.

Transaction Processing System

Computer information system that collects and stores data about transactions, and which controls decisions made while processing transactions.

Transmission Control Protocol/Internet Protocol (TCP/IP)

A set of standards for sharing data between different computers, running incompatible operating systems.

World Wide Web (Web)

De facto standard of protocols and formats for navigating, publishing and retrieving information, and transacting on the Internet and Intranet. *(Note: The above definitions are to provide the reader who may not be familiar with technical information systems and/or healthcare industry terminology, with a general understanding of the intent and uses of the present invention.

### BACKGROUND

Many electronic medical record systems have been developed to store medical information on patients. To date, the vast majority of these electronic medical record solutions have been deployed for the benefit of the physician rather than the consumer, or patient. Further these systems have not addressed medical record portability issues resulting from today's socio-economic mobility and the result is simply an electronic version of the current paper record environment. The situation has created a fragmentation of the individual's electronic medical record, prohibiting timely access to critical information during medical emergencies as well as planned office, clinic and hospital visits. In this scenario, the physician rather than the consumer, “owns” the electronic medical record, thereby disenfranchising the patient from his or her own personal medical history.

In an effort to empower the patient to take greater personal responsibility for their health and well being, the present system offers the consumer a personal, portable electronic health record that is fully owned and controlled by the patient themselves. Other companies are beginning to offer consumers a similar service. However, these companies generally rely on the consumer to directly input and update their medical record. This substantial administrative burden has constrained the widespread adoption of these services, as most consumers are incapable or unwilling to input the data. Just as importantly, physicians and other care providers are often resistant to utilize these types of systems, citing concerns regarding the accuracy and currency of information, as well as the potential for increased litigation. There is a need for a unique and powerful business process, supported by state-of-the-art technologies that address the many data collection challenges associated with the construction and update requirements of the consumer's longitudinal electronic health record. Although encouraged for some types of information (e.g., family history, allergies, etc.), the desired system does not require consumers to input any information since it is designed to automatically collect on their behalf, actual encounter-based data.

Many different health related organizations keep various parts of patient medical records, including: health insurance companies, Managed Care Organizations, HMOs, and Pharmacy Benefit Managers, as well as reference laboratories, hospitals, clinics, public health agencies, etc. The problem with these disparate forms of record retention is that the records are not accessible from a centralized location for neither the benefit of the patient, nor the provider seeking to be deliver the most cost-effective care within the context of the individual's personal and family medical history. It would therefore be advantageous to have an individual's healthcare records stored in a permanent and portable database, which can be automatically updated, over which they retain complete control of access and use.

### SUMMARY OF THE INVENTION

The MedeWorks system of the present invention serves as the Trustee of the consumer's electronic medical record. This act alone, allows for the first time, the gathering and integration of clinical, encounter, and personal information. The electronic medical record is held in trust for the consumer, with total control over access retained by the individual.

The system further provides the tools that convert the medical record into an interactive guide for the consumer to use in better managing their own health. Behind the scenes, MedeWorks is automatically gathering relevant information from a wide ID variety of sources and updating the consumers' electronic medical record. This unique approach permits any consumer to have a meaningful medical record, not just the few who have the ability and/or will take the time to input each aspect of information into their health record.

The system has an underlying technology and security architecture that supports the secure and continuous collection, integration, management, and dissemination of the consumers personal portable electronic health record. This system is comprised of a network of computers, related equipment and application software that uses the Internet and other technologies to build, maintain, update, secure and link the consumer's electronic medical record. The system is specifically engineered to excel at the secure collection and storage of sensitive personal health information.

Further, the system was designed around a robust patient-centered database management system, data encryption and secure access methodologies, and a powerful transaction-processing infrastructure. Through its integrated suite of transaction processing, database management and clinical applications, the system is capable of storing a lifelong electronic patient record, collected through batch and real-time interfaces. As appropriate, interfaces are established with health insurance companies, Managed Care Organizations, Third Party Administrators, HMOs, hospitals, reference laboratories, pharmacies, Pharmacy Benefit Managers, and other healthcare organizations, such as physician practice management systems and health information/claim clearinghouses.

A secure data repository is provided for the medical records of individuals and families. The repository's medical records, owned and controlled by the individual, may be made electronically accessible in whole or select parts to appropriate care providers, insurers and suppliers. An individual can direct that all or part of his or her medical history be transmitted to a doctor or to a hospital emergency room.

This system is primarily marketed to larger, self-insured organizations, or health plan sponsors, who underwrite the program for their employees or organization members, as a supplemental employment or health plan benefit. The system provides first, a HealthRésumé™ program in which personal healthcare information is created from existing and updated records and stored securely. The HealthRésumé™ Systemy automatically collects portions of the individual's medical records from various third parties and refreshes the consumer's personal health record on a reoccurring basis. This information is supplemented with personal data entered by the individual such as family medical history, drug and other allergies, recent health conditions, over-the-counter medications, diet and exercise patterns, etc.

The system also provides a RiskProfiler™ System which, based on medical records and statistical profiling, identifies and stratifies those at high-risk for future health problems. This is achieved based upon existing personal risk factors and medical conditions and/or an individual's non-compliance with physician-directed treatment regimens. The RiskProfiler™ System generates a communication that notifies the individual and their physician(s) (but not the employer or health insurance administrator without their consent) of the health risks and concerns. Notifications will include not only any traditional “high risk” situations but also, uniquely, any non-compliance factors (such as failure to renew prescriptions or to keep medical appointments) and risks that may arise in the future at a later age, based on family history.

Additionally, the present system provides proactive risk management services. Staff nurses contact individuals to provide advice and direction on risk management and follow-up care. They also will provide timely alerts and reminders by telephone and by e-mail as to any drug reaction and interaction concerns, and drug recalls, as well as medication compliance and physician visit needs. Clients of health information companies that have adopted just some aspects of these types of programs have realized tangible reductions in healthcare costs, ranging from 7-10% over 6-7 years. This invention provides a larger scale, more complete and innovative program; thereby increasing the savings for those implementing the system.

Use/Applicability

There are many types of organizations and the individuals within them, which can benefit by the present invention. They include health plan sponsors, healthcare providers, and administrators of health plans.

Health plan sponsors are typically employers; however they can include trade organizations, labor unions, consolidated business entities and various associations such as MRP (formerly known as the American Association of Retired Persons). When health plan sponsors contract for health care benefits, such as through an insurance company, there are many types of financial arrangements that can be employed to cover the payment of expenses. One end of the range is a fully insured health plan, whereby an insurance company collects premiums to cover estimated expenses. To the extent that actual claim losses exceed premiums collected, the insurance company is at financial risk. The other end of the spectrum is a self-insured health plan, under which a plan sponsor contracts with an organization to process and adjudicate health claims. Although a plan sponsor may have excess or stop loss insurance protection outside of the primary health plan arrangement, typically the plan sponsor is obligated to pay 100% of the cost.

The present invention can also benefit healthcare providers by helping them deliver more efficient and cost effective care. By making centralized electronic health records available, care providers have greater access to their patients' medical history, which translates to more information, generating better decisions in treatment plans. Providers include physicians, hospitals, disease management organizations, etc.

As part of the healthcare management equation, the present invention is also intended to facilitate information via computer transactions to administrators of health plans, including insurance companies, Health Maintenance Organizations (HMOs), Third Party Administrators (TPAs), Managed Care Organizations (MCOs) and Pharmacy Benefit Managers (PBMs), etc. Although the individual retains complete control over the access and use of their electronic health record, interfaces with administrators of health plans ensures the collection and management of health care data. Further, when information that is held by a managed care organization is made accessible to physicians and hospitals it can assist in treatment plans by providing a broader aspect of historical medical data.

As indicated above, there are many healthcare stakeholders relevant to the present invention; however the primary focus is large, self-insured plan sponsors which typically utilize and employ sophisticated technology resources and arrangements; thereby facilitating the transaction interfaces required of the present invention. For illustrative purposes only, both within the text and on the block diagrams contained within the accompanying Drawings, this patent application will generally reference the present invention being applied to employers who sponsor self-insured health plans. However this example is not intended to suggest limiting the scope of relationships and arrangements it will develop in the use of the present invention. In fact the present system of creating, maintaining and automatically updating consumer-owned and controlled health records will have applicability throughout the multi-faceted healthcare industry.

The present invention has been designed to achieve the following objectives:

1. Create a consumer owned and controlled medical records database that is automatically updated from a variety of sources.

2. Provide a risk analysis system to consumers and their providers, based upon an ongoing assessment of the information contained within the consumer's medical records.

3. Provide a system that can link the consumer's electronic health record to emergency medical personnel, through the initiation of a 911 emergency call, placed from either a land-line residence, cell phone or other wireless device.

4. Provide a secure database in which the demographic information on a consumer is maintained separate from the consumer's medical information.

5. Permit consumers, within the context of their own medical database, to generate and send a clinician's or physician's view of their electronic medical records, via the Web, directly to their primary care provider, specialist or other provider.

6. As authorized by the consumer, provide a self-insured organization or other funded health arrangement with health and risk alert summaries so that the organization can institute measures to reduce health risks and associated costs.

The novel features of the present invention are set-forth with particularity in the appended claims. The invention will best be understood from the following description when read in conjunction with the accompanying drawings in which:

### BRIEF DESCRIPTION OF THE BLOCK DRAWINGS

FIG. 1: system block diagram of the preferred embodiment of the present invention;

FIG. 2: block diagram outlining the operation of the system for acquiring patient information;

FIG. 3: diagram for linking the patient's records to the 911 emergency medical and residential telephone systems;

FIG. 4: block diagram for providing a means of connecting a clinical research organization with consumers who are of interest to its research efforts; and

FIG. 5: detailed block diagram of how the information in the database is stored and accessed.

### DETAILED DESCRIPTION OF THE PREFERRED EMBODIMENT

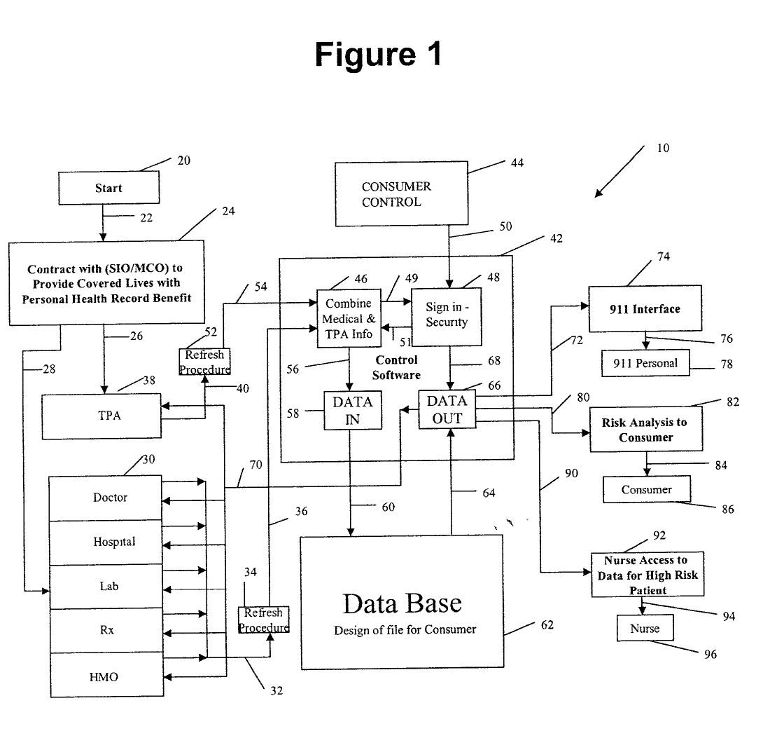

The system of the present invention described herein has been designed to provide an automated methodology to allow patients to play a more active role in the management and maintenance of their health. The system incorporates several unique capabilities and merges existing technologies in a novel design. The MedeWorks system is comprised of two major components: a back-end, bifurcated database and transaction processing infrastructure and a suite of front-end applications that are used by a variety of constituents, including healthcare consumers, physicians, emergency medical personnel, and health plan administrators. The entire architecture of the system has been developed in accordance with Transmission Control Protocol/internet Protocol (TCP/IP) technology standards and directly supports numerous Web-based applications. The overall design will be more readily understood in conjunction with the drawings, in which FIG. 1 shows a system block diagram of the present invention.

FIG. 1 shows a system in which medical information for a consumer is gathered from a variety of sources, a copy of which is stored in a database that is controlled and owned by the consumer. This database is automatically updated on a regular basis. The database information can then be transmitted by the consumer to doctors, hospitals, other healthcare providers, or insurance companies as desired by the consumer. The information can also be supplied to 911 personnel in the event of an emergency or it can be analyzed by risk analysis software to provide the consumer with information that can be used to avoid and better manage unnecessary health risks.

In FIG. 1, the process is started when MedeWorks contracts with a self-insured or managed care organization (SIO/MCO) for the benefits provided by the system. Start block 20 and line 22 represent this contact with one of the above organizations 24. When the SIO/MCO has signed-up for the system's benefits, the SIO/MCO contacts the hospitals, laboratories, Pharmacy Benefit Managers, Third Party Administrators and HMOs, etc. that provide administrative and clinical services to the covered population. Those organizations are instructed to provide to the database manager, an electronic copy of medical information on covered individuals. This is shown by lines 26 and 28 and blocks 30 and 38. Information from block 30 sources is provided via line 32, through a refresh block 34 to line 36, to the security/control software 42 for the database 62 via line 60. Similarly, information from TPA block 38 is supplied via line 40 through a refresh procedure in block 52 to line 54, and the security/control software 42 for the database 62 via line 60. In block 46 the security/control software combines the information from block 30 with the demographic information from block 38. Block 48 initiates the enrollment process in which an account number is assigned along with a password. Information cannot enter or exit the System without being approved by the security block 48. Once the information has been approved, it is transferred to the data-in block 58 via line 56, which is then transferred to database 62 via line 60.

Once the data is in database 62, it is ready for use by the consumer and for transfer to those he or she so designate. The consumer 44 can access the security/control software via line 50 representing a phone or Internet connection. The consumer is issued a card, much like a credit card, that is used to access the system. For example, if the consumer is scheduled to visit a new doctor, he or she will simply present their access card to the physician's office staff, thereby permitting them to utilize the card to access the patient's complete medical record. The security block 48 would authorize via line 68, the release of data on line 64 through the data-out block 66 to line 70, and then to the doctor's office in block 30. In the same way, any of the entities in block 30 could access the database 62.

An alternative embodiment of this process provides a system in which the security block 48 has a database that holds Unique Provider Identification Numbers (UPIN) such as the American Medical Association (AMA), Drug Enforcement Agency (DEA) or Medicare UPIN information for each service provider. The consumer 44 can choose to have his or her records accessed only with their card number and PIN number or they can choose to allow a service provider access by using the card number and the services providers UPIN number. The consumer could also choose to allow anyone with a UPIN number to access his or her medical records.

If the consumer desires, he or she could authorize access to the information by the 911 system so in the event of a medical emergency, the responding emergency medical personnel could access health records on a real-time basis. In this system, the 911 emergency personnel 78 could access the System via line 76 through a 911 interface 74 and receive the medical information via line 72. However, unless the consumer has pre-authorized automatic access, the electronic health record can only be transferred to emergency personnel in one of the three ways. First, with the MedeWorks coded identification card and Pin number; second, with the MedeWorks coded identification card and emergency physician's UPIN; or third, with a call originating from a 911 system phone line (verified by a MedeWorks look-up table) and the emergency physician's UPIN. Alternatively, a consumer could pre-authorize that select medical information such as medicine-related allergies be made available electronically to emergency personnel.

The consumer 86 can also access the system via line 84, through a risk analysis block 82 to receive a risk analysis based on their updated medical records via line 80.

Another feature of the system is shown in block 92 in which a nurse 96 can have access via line 94 and ultimately via line 90 to a patient's medical files in the situation that a patient is at high risk for failure to take necessary medicine or other reasons due to non-compliance of prescribed treatment regimens.

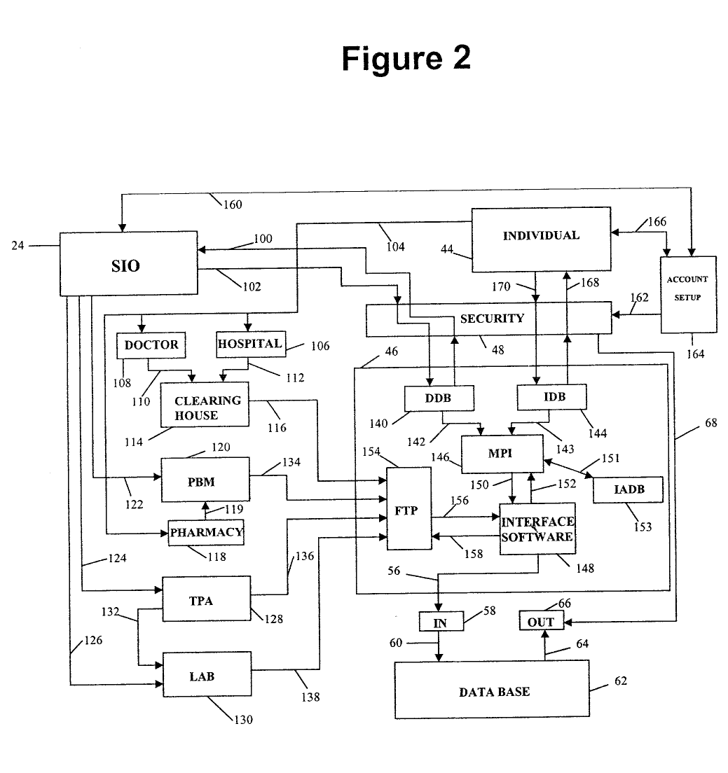

FIG. 2 is a more detailed block diagram of the method of gathering medical information from the various sources generally referred to in the discussion of FIG. 1. The major components of FIG. 2 are the Self Insured Organization/Managed Care Organization (SIO/MCO) 24, the clearinghouse 114, the Pharmacy Benefit Manager (PBM) 120, the Third Party Administrator (TPA) 128, the Laboratory 130, the individual 44 and the expanded block 46. This block diagram is intended to show how the medical information for an individual 44 is gathered and organized for storage in database 62.

First, an account is setup for a group or an individual. When a group is signedup for coverage, an account setup procedure is initiated in block 164. As part of this procedure, the security block 48 is programmed to identify and accept demographic information on individual employees/members from the SIO/MCO 24. The SIO/MCO then downloads information on each person who will be covered by the benefit, via lines 100 and 102. The security block 48 passes this information to the Demographic Data Base (DDB) 140. The DDB 140 then passes the information to the Master Person Index (MPI) 146 via line 142 when the MPI is ready for the information. In a similar manner, an individual 44 can subscribe to the service by contacting the account setup block 164 via line 166, which represents communication through an 800 number, the Internet, or faxed application. Once contacted, the account set-up block 164 provides for individual access via line 162 through the security block 48 to the Individual Data Base (IDB) 144. As a result, the individual can provide his or her own demographic and personal health information. This information is then added to the MPI 146 via line 143 so that it can be matched to medical information from other sources as it becomes available. An individual that is covered by a SIO/MCO can also provide additional medical or demographic information through the IDB 144 interface.

Once the information from the DDB 140 and IDB 144 is stored in the MPI 146, it can be matched to medical information from other sources that provide medical information to the File Transfer Protocol (FTP) server 154. After the SIO/MCO has signed-up for the benefit, it instructs the Pharmacy Benefit Manager (PBM) 120, its Third Party Administrator (TPA) 128, and any laboratories 130 that it contracts with, via lines 122, 124 and 126 respectively, to transfer all medical information on covered individuals to the FTP server 154 via lines 134, 136 and 138. The FTP server 154 receives and holds this information for matching with the files that have previously been set-up in the MPI.

Another method of providing information to the FTP server 154 is through the clearinghouse 114 via line 116. In this example, an individual who has an account within the system, either through a SIO/MCO, or as an independent individual, provides their system identification number (this is given to the individual when their account is setup) to a doctor 108 or a hospital 106. The doctor 108 or hospital 106 may process the individual's claims, lab orders and prescriptions through a clearinghouse via lines 110 and 112 respectively. The system of the present invention, contemplates that an existing relationship between the clearinghouse 114 and the system of the present invention will allow the clearinghouse to forward any healthcare information to the FTP server 154 via line 116 as well as any payor or insurance company. This system allows the FTP server 154 to capture any information generated for an individual as the result of a doctor or hospital visit. If the individual is given a prescription as a result of the visit, the information relating to the processing of that prescription can be gathered by the FTP server 154. The pharmacy 118 provides the information to the PBM 120 via line 119, which in turn provides the information to the FTP server 154 via line 134.

The FTP server 154 now holds the medical information for covered individuals and the MPI holds the demographic information from the SIOs/MCOs 24 and the individuals 44. The Interface Software 148 then matches the information from the FTP server 154 with the information from the MPI 146 and forwards it via lines 56 and 60 to the database 62. The FTP server 154 receives information from the previously discussed sources on a reoccurring basis so that a covered individual's file is continuously updated. If an individual's participation in the plan ends, the MPI for that individual is moved via line 151 to an Inactive Database (IADB) 153 (holding position) and periodically reviewed via line 151 to determine whether the individual has become re-employed or joined a participating organization within the MedeWorks client base.

This will help preserve historical medical records. As previously discussed, the individual has control over the use of their information in the database 62 and they can designate how, when, and by whom that information is used.

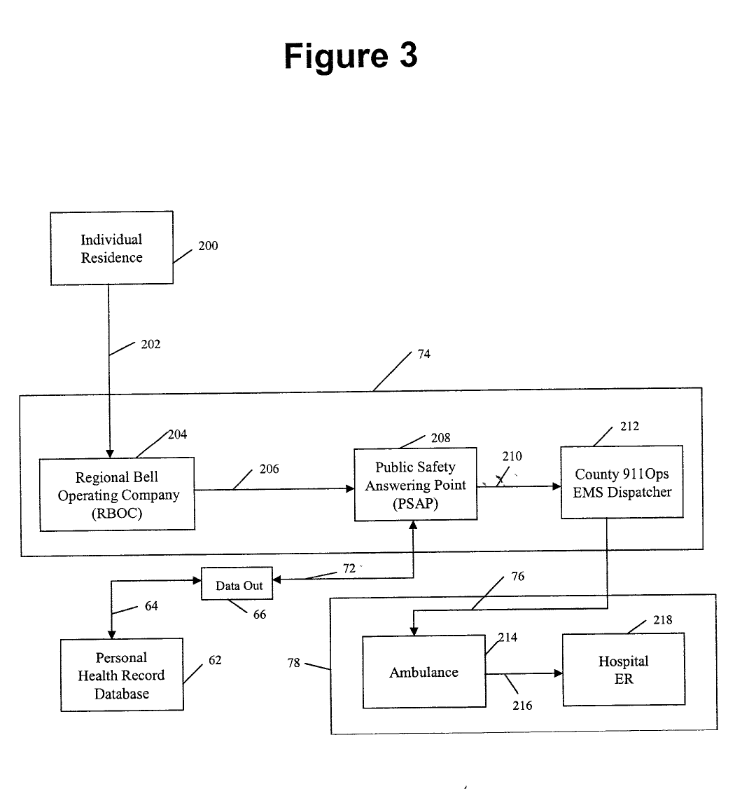

FIG. 3 shows how information can be used through a 911 emergency access system. In this example an individual 44 (FIG. 2) has previously authorized use of their medical information through the 911 system. In this method, a call is placed from a residence 200, or from a cell phone (not shown) through line 202 to a local telephone operating company such as a Regional Bell Operating Company 204. Depending on the system, the caller ID information such as phone number and address is passed to a Public Safety Answering Point (PSAP) 208 via line 206. The PSAP utilizes a look-up table that has been preprogrammed with an individual's medical information number. When the look-up table finds a match, it retrieves the information via line 72, data-out block 66 and line 64 that is connected to the database 62. The PSAP forwards the information via line 210 to a 911 Dispatcher 212. The Dispatcher 212 then sends the information to the emergency personal 214 or hospital ER 218 by voice, Internet, wireless, fax or e-mail. In this way, updated medical information can be automatically provided to emergency personnel, on a real-time basis, before they arrive on the scene of the medical emergency. The information is also then available to emergency room personnel when the patient arrives at the hospital.

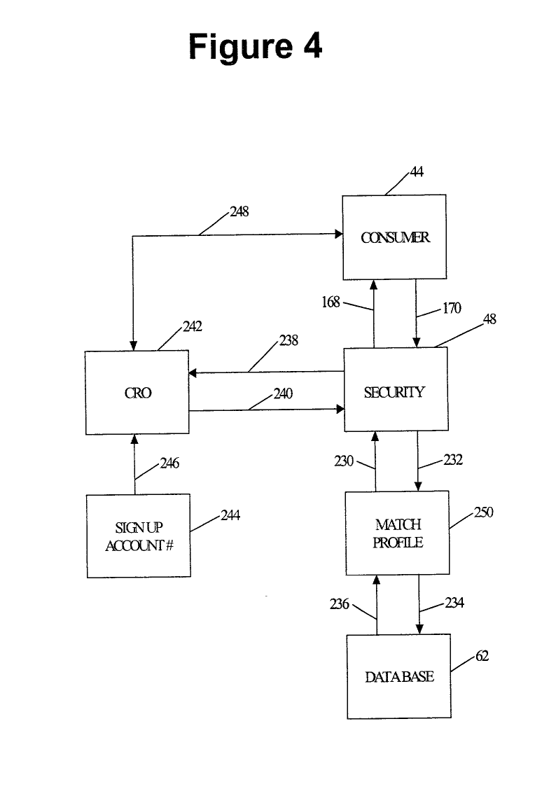

FIG. 4 shows an aspect of the present invention in which a clinical research organization (CRO) can be matched with people who have a medical disorder in which the CRO has a research interest. In this System a CRO is contacted and signed onto a program in which it can submit a request to the database manager for a list of individuals who have medical conditions it is researching. The CRO is contacted and given an account number and a password, block 244 and line 246, for access and identification. The CRO can then submit a request on line 240 for individuals with certain medical disorders. The security block 48 identifies the request and forwards the request via line 232 to a matching software block 250. This software has access to the database 62, via lines 234 and 236, so that it can identify and list all of the consumer records in database 62 that match the CRO's request. The matching software block 250 then passes the matching records to the security block 48 via line 230. The security block 48 then contacts the consumer via line 168 to determine whether an individual has an interest in participating in the CRO's study. If the consumer is not interested in participating, the CRO will not receive any information about the consumer. If the consumer is interested in participating, the consumer 44 will then be given information to allow he or she to contact the CRO directly, via line 248 or the CRO 242 can be given information so it can contact the consumer. (Both the consumer 44 and the CRO 242 can be given information so that each can contact the other.)

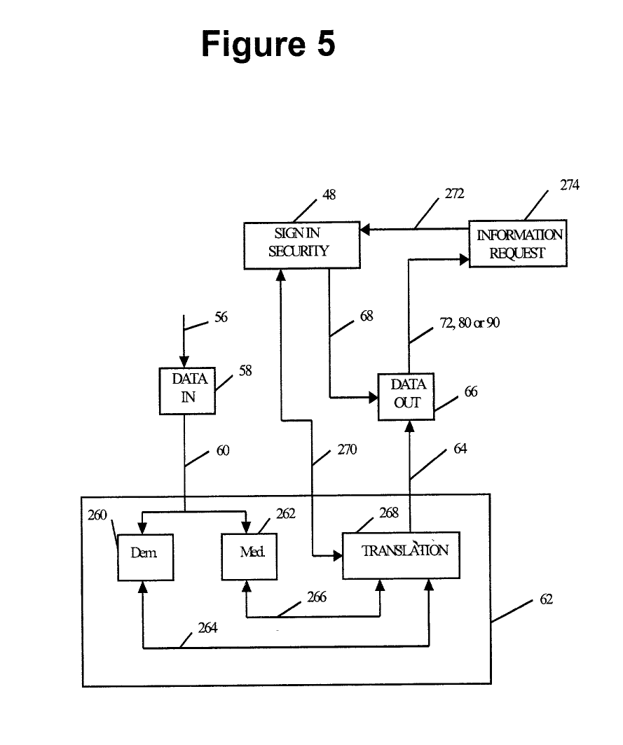

FIG. 5 shows a more detailed block diagram of how a consumer's medical and demographic information is stored and accessed. FIG. 2 shows how demographic information is gathered from an organization on an individual. It also shows how am medical information is gathered and updated from various medical sources. In FIG. 5, Demographic information is identified as such and transferred via line 56 to the data in block 58. The information is then transferred via line 60 to the demographic database 260. This information is tagged with a unique identifier so that it can later be matched to the corresponding medical information for that consumer. In the same manner, medical information for the consumer is identified as such, tagged with an identifier and then transferred via line 60 to the medical information database 262. Anyone looking at the information in either of the databases 260 or 262 would not be able to match-up the information as belonging to any person unless they had access to the translation security algorithm located in translation block 268, which is represented by lines 264 and 266, respectively.

When a request for information on a person is received from block 274 via line 272, the sign-in/security block 48 verifies the requester's identification number, along with a valid PIN or UPIN number as previously discussed. If the numbers are valid, then the request is passed via line 270 to the translation block 268. The translation block then uses a security algorithm to match the demographic information in block 260 with the medical information in block 262 to generate a complete file for transfer to the requestor. This information is requested and gathered via line 264 and 266. When the file is generated in block 268, the security block 48 is notified via line 270 so that it can communicate with the data-out block 66, via line 68, to transfer the information on one of lines 72, 80 or 90 (FIG. 1) to the requesting party. The data-out can also be sent to any requester by e-mail, fax, etc. General features of the system are discussed below as they relate to the system shown in FIG. 1.

The system is built around the individual consumer's (patient's) electronic medical record. The medical record is comprised of demographic data collected from the patient and medical data collected electronically from various third parties. The by process of gathering data from the patient directly employs either conversant web browser technology, or direct phone interviews with clinicians or faxed application. The automatic updating of the consumer's database record with medical data requires an interface engine to assimilate, decipher, identify and post the data. The design of the interface engine system component is discussed below.

Key factors in the overall system design are the issues of data ownership, data integrity, data access, confidentiality and allowed uses of the data. Personal medical record information is fragmented because of the traditional problem of various industry stakeholders, such as providers, and payors, etc., in not wishing or incapable of electronically sharing or releasing medical records information to other authorized third parties.

This fragmentation has generated the sub-optimization of health care management and is indirectly responsible for disability and mortality as described in detail by the Nov. 29, 1999 Institute of Medicine report describing medical error problems. The design of this system includes a business model whereby the self-insured employer, union, or health plan, etc. are contracted as the sponsors of the consumer's personal health record. The economic benefits that will accrue to them from maintaining healthier employees justify their absorbing some or all of the costs of the service.

As a part of the service contract, the sponsor waives any and all rights to any information from the resultant databases, except for anonymous summary information. This allows the service provider to enter into a confidentiality agreement with individuals, guaranteeing their ownership and the privacy of the data. Without this business model, it is commercially impossible to merge personal and clinical data. As a result, the database represents a unique collection of personal and clinical data. This database is then analyzed with a rules-based software algorithm to determine the health M risks that exist for the patient. The analysis tool provides four categories of health risks:

1. Patients with great probability of incurring near-term, high cost medical expenses;

2. Patients that have a known health condition, not complying with the physician's treatment plan, who will likely experience high cost medical expenses if they remain outof-compliance;

3. Patients with an existing health problem whose treatment regimen is likely to be ineffective or places them at greater health risk; and

4. Patients who have not yet exhibited a medical disorder, but are at high-risk to develop an expensive medical condition, (for example based on family medical history).

Although the ability to define the first of the above risk category is generally available, the ability to define the second risk category requires the capability to not only look for positive triggers, but also the ability to identify the negative presence of anticipated events. The ability to define the third category requires access to personal information in the database. The ability to identify all three categories makes the system unique.

To address these and other vital business requirements, the system uses a state-of-the-art computer system, employing a “best of class” strategy. The system is the underlying technology and security infrastructure that supports the consumer's lifelong electronic health record. The system is comprised of a network of computers, related equipment and software that uses the Internet and other advanced technologies to build, maintain, secure and link the consumer's medical record. Given the public's concern regarding the security and confidentiality of personally identifiable healthcare information, the system was specially engineered to excel at the secure collection and storage of sensitive personal health information as discussed with reference to FIG. 5. Specifically, the database has been constructed to partition demographic information from clinical data. This bifurcation prevents a security breach that would permit the breaching party to identify the specific medical records and history of any particular individual whose information is stored in the database. The records in the demographic and clinical history data-bases can only be linked through a third data base that stores a secret algorithm, unlocking the code to link the databases together.

The system of the present invention has been described with reference to FIGS. 1 through 5, however it is understood that a person of ordinary skill in the art could substitute different systems and methods for those described and shown in the specification and drawings to make and use the invention as claimed below.

What is claimed is:

1. A method of creating and automatically updating a consumer owned and controlled personal, portable electronic health record system, the method comprising the steps:
acquiring and updating an individual's medical information from various third party healthcare organizations and entering said information into a database;
making said information available through use of a secure card to recipients designated by said individual; and
submitting the data on said individual to the individual for supplementation.

2. The method of claim 1, further comprising the step of:
permitting the individual to correct and update the data and health information, related to his or her own submission.

3. The method of claim 2 further comprising the step of:
supplementing the stored database with additional data as to the individual from authorized sources.

4. The method of claim 3 including the step of:
having the stored medical information identified as being supplied by the consumer or a healthcare provider.

5. The method of claim 1 wherein:
the demographic data is stored in a separate data base from said medical information; and
connecting said demographic information with said medical information with a translation algorithm.

6. A method of profiling health risks of an individual whose personal health data is stored in an electronic database owned and controlled by the individual, comprising the steps:
electronically reviewing the health data of said person and comparing same with a second database of statistical risk and non-compliance profiles for analysis;
identifying health risks, concerns or projections as to the individual; and
providing such health risks, concerns or projections to the individual, either directly or through their healthcare practitioner.

7. The method of claim 6 wherein:
the health risks, concerns or projections for the individual are not provided to any employer, insurer, or other healthcare practitioner except in an anonymous summary of many such individuals.

8. The method of claim 6 wherein:
the health risks, concerns and projections for the individual that are provided to the individual, include those arising from non-compliance with best medical practices and specific treatment regimens, including routine preventive screening and diagnostic tests and procedures, renewing prescriptions, and keeping medical appointments.

9. The method of claim 6 wherein:
the health risks, concerns or projections for the individual that are provided to the individual include those likely to arise in the future from one or more of family, drug, and other medical history factors.

10. The method of claim 5 wherein:
an employer, labor union or health plan of the individual, sponsors some of all of the costs of practicing the method.

11. A method of providing selected health information of an individual to healthcare practitioners, employers, insurers, and others from an electronic database owned and controlled by the individual, the method comprising the steps:
establishing a secure link between the database and an intended recipient of the information;
establishing what information is authorized by the individual and on what conditions the information should be distributed to said recipient; and
transmitting, upon occurrence of said condition, the authorized personal health information of the individual from the secure storage over said secure link to the selected healthcare practitioner, insurer, employer or another.

12. The method of claim 11 wherein:
the conditions include a prescription of a second drug or medication, which interacts badly with a first drug or medication the individual is taking, whereby pertinent health history information of the individual is pre-authorized to be transmitted to a pharmacy or other dispenser of said first drug or medication.

13. The method of claim 12 further comprising the step of:
notifying the individual of the drug or medicine interaction problem.

14. The method of claim 11 wherein:
an employer, labor union or health plan of the individual, sponsors in part or in full, the costs of practicing the method.
